(19) United States
(12) Patent Application Publication
(10) Pub. No.: US 2008/0275645 A1
(43) Pub. Date: Nov. 6, 2008

(54) IN-VEHICLE NAVIGATION APPARATUS AND METHOD

(75) Inventor: Nobuyuki Hoshino, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/038,591

(22) Filed: Feb. 27, 2008

(30) Foreign Application Priority Data
Mar. 7, 2007 (JP) 2007-057626

(51) Int. Cl. G01C 21/34

(52) U.S. Cl. 701/209

(57) ABSTRACT

An in-vehicle navigation apparatus and method displaying a route from a current position of a vehicle to a destination on a map on a display screen. The in-vehicle navigation apparatus and method include accepting an entry of a destination, detecting a current position, storing a plurality of pieces of map information at different scales, and specifying a route from the current position detected to the destination. The apparatus and method include calculating a remaining distance from the current position to the destination or from the current position to a next en-route destination on the route set, storing a correspondence relationship between remaining distances, and scales of the map and extracting a scale corresponding to the remaining distance calculated, extracting map information at the corresponding scale, and displaying the map information on the display screen.

### CROSS-REFERENCE TO RELATED APPLICATIONS

This application is related to and claims the benefit of priority from Japanese patent application no. 2007-57626, filed on Mar. 7, 2007, the entire contents of which are incorporated herein by reference.

### BACKGROUND

1. Field

The present invention relates to in-vehicle navigation apparatus(es) providing guidance on a route from a current position of a vehicle to a final destination, and more particularly, to a technique including automatically changing a scale of a displayed map according to circumstance(s).

### SUMMARY

The disclosed in-vehicle navigation apparatus and method include displaying a route from a current position of a vehicle to a destination on a map on a display screen. The in-vehicle navigation apparatus and method include accepting an entry of a destination, detecting a current position, storing a plurality of pieces of map information at different scales, specifying a route from the current position detected to the destination. The apparatus and method include calculating a remaining distance from the current position to the destination or from the current position to a next en-route destination on the route set, storing a correspondence relationship between remaining distances, and scales of the map and extracting a scale corresponding to the remaining distance calculated, extracting map information at the corresponding scale, and displaying the map information on the display screen.

The apparatus and method include detecting a traveling speed of a vehicle, storing correspondence relationships between vehicle speeds and scales of a map to be displayed, extracting a scale corresponding to a vehicle speed detected, extracting map information having the scale corresponding to the vehicle speed and displaying map information.

Additional aspects and/or advantages will be set forth in part in the description which follows and, in part, will be apparent from the description, or may be learned by practice of the invention.

### BRIEF DESCRIPTION OF THE DRAWINGS

These and/or other aspects and advantages will become apparent and more readily appreciated from the following description of the embodiments, taken in conjunction with the accompanying drawings of which:

FIG. 1 is a block diagram illustrating an outline of an in-vehicle navigation apparatus;

FIG. 2 is a main flowchart illustrating operation(s) of an in-vehicle navigation apparatus;

FIG. 3 is a flowchart illustrating a setting-entry accepting process performed in an in-vehicle navigation apparatus;

FIG. 4 illustrates an entry screen displayed on a display screen in the setting-entry accepting process shown in FIG. 3;

FIG. 5 illustrates a structure of a setting table used in the setting-entry accepting process shown in FIG. 3;

FIG. 6 is a flowchart illustrating a moving-route determining process performed in an in-vehicle navigation apparatus;

FIG. 7 illustrates a structure of an en-route destination table set in the moving-route determining process shown in FIG. 6;

FIG. 8 is a flowchart illustrating a display process performed in an in-vehicle navigation apparatus;

FIG. 9 illustrates a structure of a speed-based scale table used in the display process shown in FIG. 8;

FIG. 10 illustrates a structure of a remaining-distance-based scale table used in the display process shown in FIG. 8;

FIG. 11 illustrates a structure of a road-type-based scale table used in the display process shown in FIG. 8;

FIG. 12 illustrates a structure of a map information database (DB) provided in an in-vehicle navigation apparatus;

FIG. 13 illustrates an exemplary default setting screen displayed using an in-vehicle navigation apparatus;

FIG. 14 illustrates an exemplary screen in which a map is displayed at a small scale using an in-vehicle navigation apparatus;

FIG. 15 illustrates an exemplary screen in which a map is displayed at a large scale using an in-vehicle navigation apparatus;

FIG. 16 is a flowchart illustrating a setting-entry accepting process performed in an in-vehicle navigation apparatus;

FIG. 17 illustrates an entry screen displayed on the display screen in the setting-entry accepting process shown in FIG. 16;

FIG. 18 illustrates a structure of a setting table used in the setting-entry accepting process shown in FIG. 16;

FIG. 19 illustrates a structure of a scale identification (ID) table used in an in-vehicle navigation apparatus;

FIGS. 20A and 20B are flowcharts illustrating a display process using speed and remaining distance for an in-vehicle navigation apparatus as parameters;

FIGS. 21A and 21B are flowcharts illustrating a display process using speed and road type for an in-vehicle navigation apparatus as parameters; and

FIGS. 22A and 22B are flowcharts illustrating a display process using the remaining distance and the road type for an in-vehicle navigation apparatus as parameters.

### DETAILED DESCRIPTION OF THE EMBODIMENTS

Reference will now be made in detail to the embodiments, examples of which are illustrated in the accompanying drawings, wherein like reference numerals refer to the like elements throughout. The embodiments are described below to explain the present invention by referring to the figures.

In general, a scale of a map displayed on a display screen of an in-vehicle navigation apparatus for a vehicle is set by a user by selecting a desired scale. However, it is bothersome to manually change a scale of the displayed map according to circumstance(s) while the vehicle is traveling. When a vehicle approaches an en-route destination of a route for which guidance is provided, such as an intersection where the vehicle turns right or left or a place where the vehicle needs to change lanes, besides the map displayed at the selected scale, a separate window occupying about one-half of the screen often pops up to display an enlarged map. However, since the enlarged map is displayed in a small area that is about one-half the screen, a relationship to circumstance(s) is not clear to the user. For example, the vehicle may travel past an intersection where the user has intended to turn.

The present invention overcomes the foregoing and other problems.

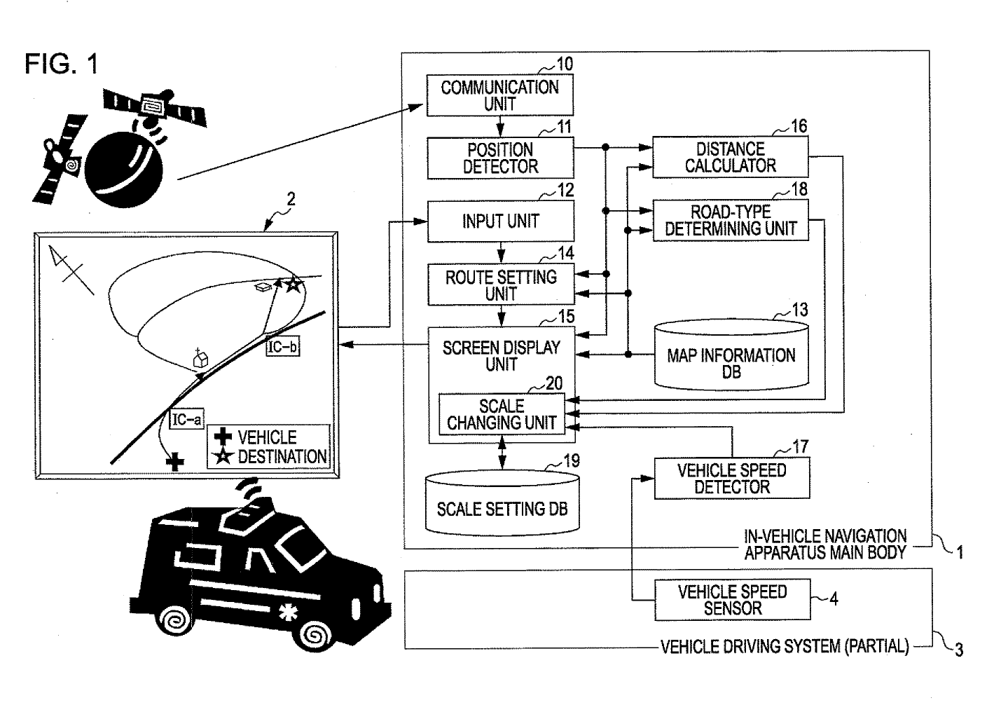

An in-vehicle navigation apparatus according to exemplary embodiments of the present invention will be described with reference to the drawings. Referring to FIG. 1, a schematic structure of an in-vehicle navigation apparatus according to an embodiment will be described. As shown in FIG. 1, the in-vehicle navigation apparatus may include an in-vehicle navigation apparatus main body (hereinafter simply referred to as a “main body”) 1 obtaining a route from a current position of a vehicle to a final destination and a touch-panel display screen (monitor) 2 displaying the obtained route on a map. A vehicle driving system 3 includes a vehicle speed sensor 4 detecting a traveling speed of a vehicle.

The main body 1 includes a communication unit 10 receiving a radio wave from a global positioning system (GPS) satellite, a position detector 11 detecting a current position of a vehicle on the basis of information received by the communication unit 10, an input unit 12 accepting (receiving) an entry of a final destination, a parameter for changing a scale, etc., through the touch panel of the display screen 2, a map information database (DB) (storage unit) 13 storing a plurality of pieces of map information at different scales, a route setting unit 14 referring to the map information DB 13 and specifying a route from the current position detected by the position detector 11 to the final destination accepted by the input unit 12, and a screen display unit 15 for reading map information from the map information DB 13 in accordance with the route specified by the route setting unit 14 and displaying the map information on the display screen 2. These components may be basic components common to existing in-vehicle navigation apparatuses.

Besides the foregoing components, the in-vehicle navigation apparatus according to an embodiment includes a distance calculator 16 calculating a remaining distance from the current position of the vehicle, which is detected by the position detector 11, to a next en-route destination on or within the route, a vehicle speed detector 17 detecting a traveling speed of the vehicle on the basis of a signal output from the vehicle speed sensor 4, a road-type determining unit 18 referring to the map information DB 13 based on the current position of the vehicle and specifying a road type at the current position, and a scale setting DB 19 storing correspondence relationship(s) of a vehicle speed, a remaining distance, and a road type to the scale of a map displayed on the display screen 2. The screen display unit 15 includes a scale changing unit 20 giving (providing) an instruction to change a scale of a map on the basis of a selection of a parameter using the input unit 12.

In the case where a user selects a vehicle speed as a parameter for changing the scale, the scale changing unit 20 in the screen display unit 15 reads a scale corresponding to the vehicle speed detected by the vehicle speed detector 17 from the scale setting DB 19. In the case where the user selects the remaining distance as a parameter for changing the scale, the scale changing unit 20 reads a scale corresponding to the remaining distance calculated by the distance calculator 16 from the scale setting DB 19. In the case where the user selects the road type as a parameter for changing the scale, the scale changing unit 20 reads a scale corresponding to the road type determined by the road-type determining unit 18 from the scale setting DB 19. The screen display unit 15 reads map information at a corresponding scale from the map information DB 13 and displays the map information on the display screen 2.

Various embodiments are herein described in conjunction with operation(s) of the in-vehicle navigation apparatus. The embodiments are different from each other in at least the setting of a parameter(s) to change a display scale. In an embodiment, a user is required to select one of three parameters including a speed, a remaining distance, and a road type. Alternatively, a user can select multiple parameters from among parameters according to another embodiment.

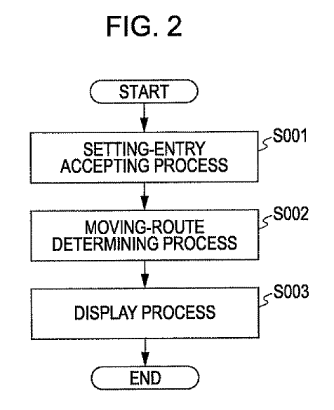

FIGS. 2 to 15 show one embodiment. Hereinafter, a description will be given by sequentially referring to FIGS. 2 to 15. FIG. 2 is a flowchart showing a flow of an overall operation. As shown in FIG. 2, when power is supplied to an in-vehicle navigation apparatus according to an embodiment and the overall process starts, the in-vehicle navigation apparatus performs a setting-entry accepting process in operation S001. When the setting-entry accepting process is completed, the in-vehicle navigation apparatus performs a moving-route determining process in operation S002. Thereafter in operation S003, the in-vehicle navigation apparatus performs a display process providing guidance on a route as to an actual traveling.

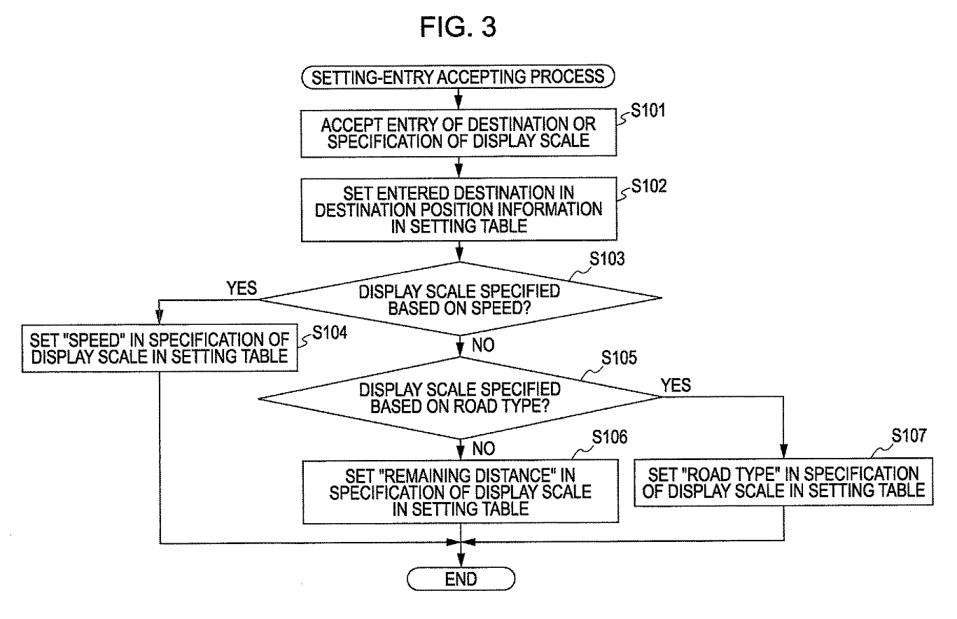

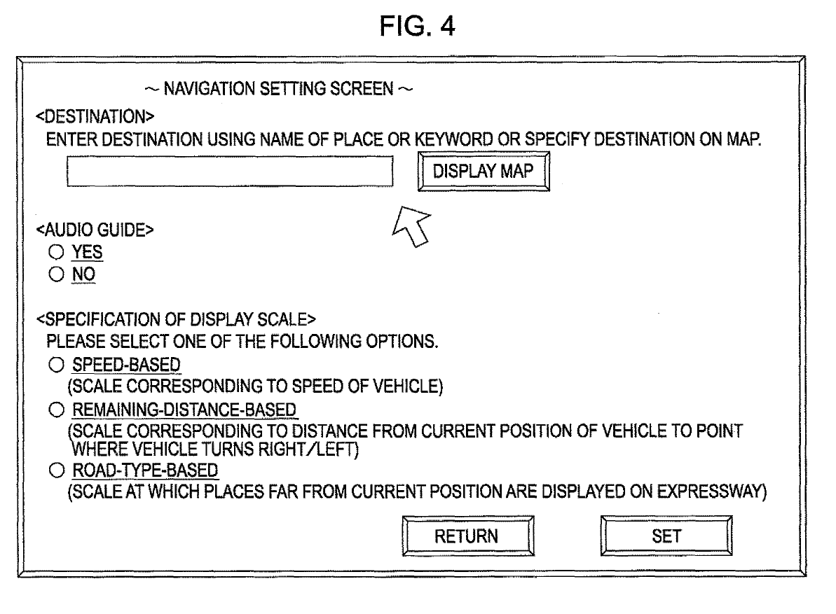

The setting-entry accepting process in operation S001 is a process of prompting a user to enter a destination and to select a parameter for changing a scale of a map. More specifically, as shown in FIG. 3, the input unit 12 displays in operation S101 an entry screen shown in FIG. 4 on the display screen 2 and accepts from the user an entry of a destination and specification of a parameter for changing the display scale. The entry screen (navigation setting screen in FIG. 4) includes a field for setting a destination, a field for setting an audio guide, and a field for setting a specification of a display scale. The field for setting the destination includes a text box for entering the destination (final destination) in terms of the name of a place, a keyword, etc. and a map display button for displaying a map so that the user can specify the destination on the map. The field for setting an audio guide may include radio buttons for setting (indicating) whether audio guide is necessary or not. The field for setting the specification of the display scale includes three radio buttons for selecting corresponding item(s) including a speed, a remaining distance, and a road type, where only one of the three items is selectable according to an embodiment. While selectable options provided via the entry screen (navigation setting screen) of FIG. 4 are described using particular user interface(s), the present invention is not limited to any particular type of interface for selecting and indicating item(s) via the display screen 2. For example, a menu option prompting entry of the specification of a display scale of a map may be provided.

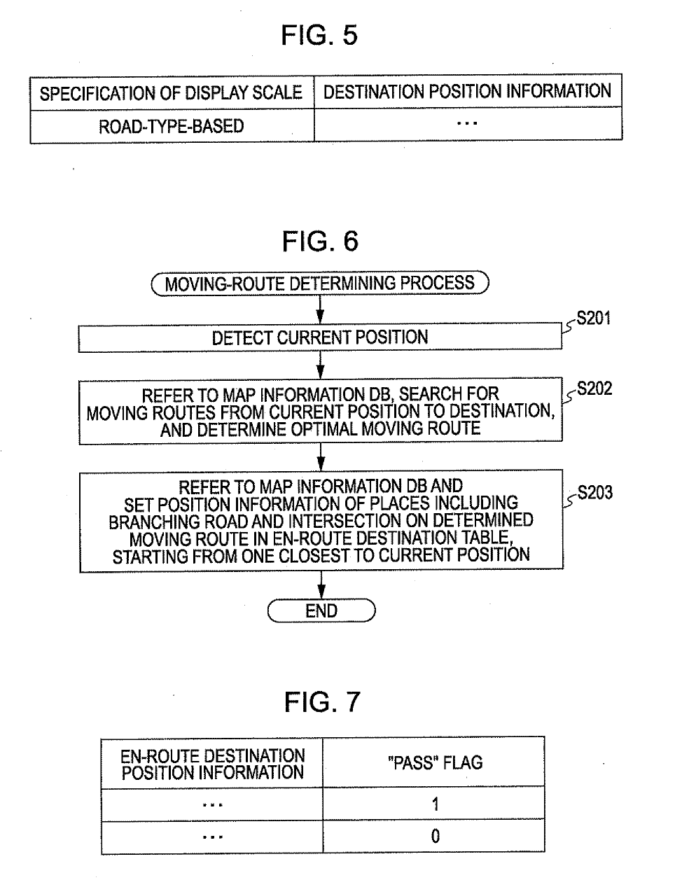

When the user enters necessary information on the entry screen (FIG. 4), the input unit 12 registers in operation S102 the entered destination (final destination) in destination position information in a setting table. The setting table may include, as shown in FIG. 5, a field for storing destination position information and a field for storing specification of a parameter for changing the display scale.

In operations S103 to S107, the input unit 12 determines which of parameter(s) has been set on the entry screen to change the scale and sets the determined parameter in the setting table. In the example shown in FIG. 5, “broad type” is set as the parameter.

In particular, at operation S103, the process determines whether display scale is specified based on speed. When determining that the display scale is specified based on speed, the process proceeds to operation S104 of setting speed in specification of display scale in setting table. When determining that the display scale is not specified based on speed, the process determines whether the display scale is specified based on road type at operation S105.

When determining that the display scale is specified based on road type, the process proceeds to operation S107 of setting road type in specification of display scale in setting table. On the other hand, when the process determines that the display scale is not specified based on road type, the process proceeds to operation S106 of setting remaining distance in specification of display scale in setting table.

When the setting is completed, the route setting unit 14 performs a moving-route determining process shown in FIG. 6. In operation S201 of the process, the position detector 11 detects a current position of a vehicle on the basis of, for example, a GPS signal from the communication unit 10. Thereafter in operation S202, the route setting unit 14 refers to the map information DB 13, searches for moving route(s) from the current position to the final destination, and determines an optimal route. In operation S203, the route setting unit 14 registers point(s) where a user should pay special attention appearing on the determined route, such as a branching road, an intersection, etc., as en-route destinations in an en-route destination table having a plurality of records, as shown in FIG. 7, starting from the one closest to the current position. In the en-route destination table, each registered en-route destination record has a “pass” flag. Flag 1 is set to an en-route destination that has been driven past, and flag 0 is set to an en-route destination that has not been driven past.

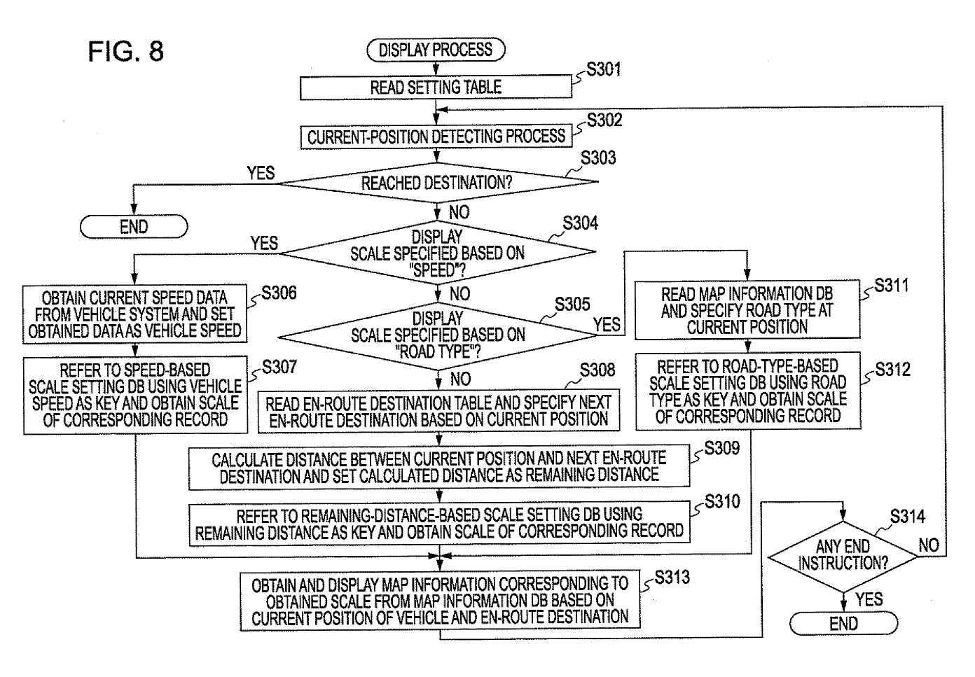

When the route is determined, the screen display unit 15 displays a guide screen on the display screen 2 in accordance with a display process shown in FIG. 8. In the display process, the screen display unit 15 reads in operation S301 the setting table that has been set using the setting-entry accepting process and reads the final destination and the parameter for changing the scale.

Next, the screen display unit 15 detects in operation S302 the current position using the position detector 11 and determines in operation S303 whether the vehicle has reached the final destination. The process from operation S302 onward is repeated until it is determined in operation S303 that the vehicle has reached the final destination or an end instruction is given from the user in operation S314, which will be described below in detail.

In operations S304 and S305, the screen display unit 15 determines which of the parameters has been set to change the scale. When determining that the speed has been set as a parameter, in operation S306, the screen display unit 15 obtains a current speed data from the vehicle speed detector 17 having received an output of the vehicle speed sensor 4. In operation S307, the scale changing unit 20 in the screen display unit 15 searches a speed-based scale table stored in the scale setting DB 19 using the obtained vehicle speed as a key and obtains a value of a scale corresponding to the vehicle speed.

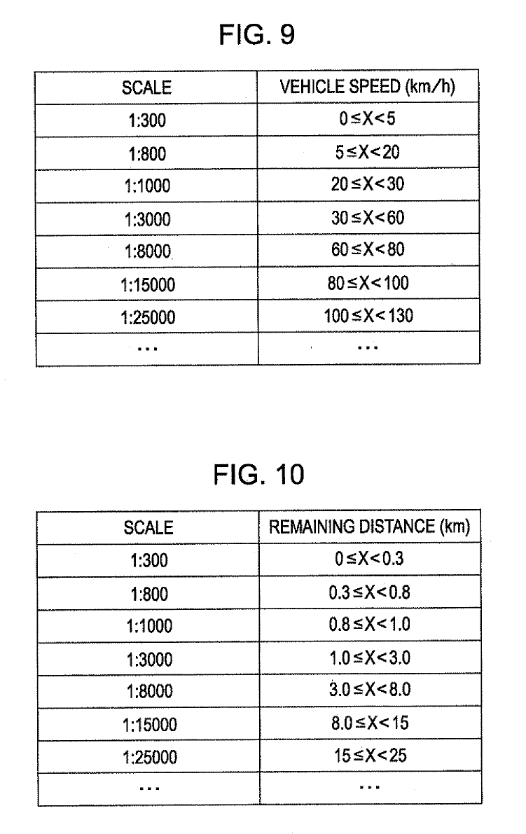

The speed-based scale table has a structure shown in FIG. 9. A scale of a map to be displayed is defined according to a predetermined range of vehicle speed(s). The slower the vehicle speed, the larger the scale (the smaller the denominator). The higher the vehicle speed, the smaller the scale. In this manner, scales are defined operation by operation.

In contrast, in the case where a remaining distance is set as a parameter for changing a scale, the distance calculator 16 reads in operation S308 the en-route destination table and specifies the next en-route destination based on the current position. In this example, the en-route destination defined in, among records having “pass” flags indicating 0, the record at the beginning is specified as the next en-route destination. Thereafter, the distance calculator 16 calculates in operation S309 a distance between the current position and the next en-route destination and sends a calculated distance as the remaining distance to the scale changing unit 20 in the screen display unit 15. In operation S310, the scale changing unit 20 searches a remaining-distance-based scale table stored in the scale setting DB 19 using the obtained remaining distance as a key and obtains a value of a scale corresponding to the remaining distance.

The remaining-distance-based scale table has a structure shown in FIG. 10. A scale of a map to be displayed is defined according to a predetermined range of remaining distance(s). The shorter the remaining distance, the larger the scale (the smaller the denominator). The longer the remaining distance, the smaller the scale. In this manner, scales are defined operation by operation.

In contrast, in the case where a road type is set as a parameter for changing a scale, the road-type determining unit 18 reads in operation S311 the map information DB 13, specifies the road type at the current position, and sends the specified road type to the scale changing unit 20 in the screen display unit 15. In operation S312, the scale changing unit 20 searches a road-type-based scale table stored in the scale setting DB 19 using the obtained road type as a key and obtains a value of a scale corresponding to the road type on which the vehicle is currently traveling.

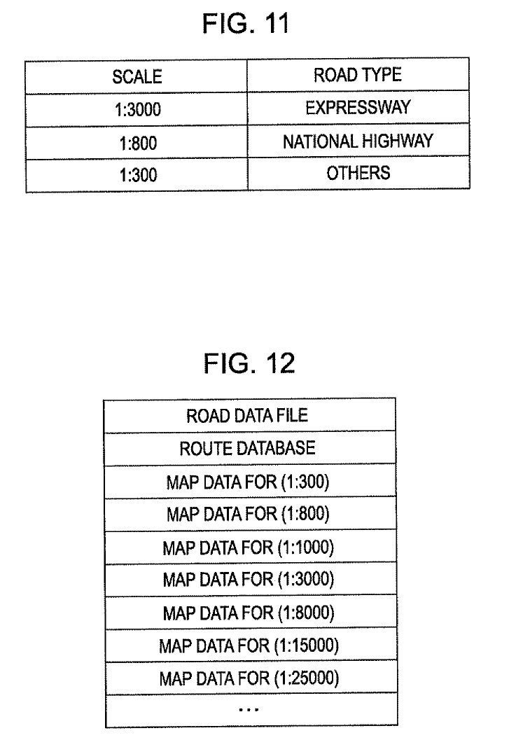

The road-type-based scale table has a structure shown in FIG. 11. For example, three road types including expressways, national highways, and other roads are defined. A scale corresponding to each type is defined. A smaller scale (larger denominator) corresponds to expressways since detailed information about the neighborhood is unnecessary for the user. A larger scale corresponds to national highways, and the largest scale corresponds to other roads.

In any case, when the scale changing unit 20 selects a scale at which the map is to be displayed, the screen display unit 15 reads in operation S313 map data at the selected scale from the map information DB 13 on the basis of the current position and the next en-route destination and displays the read map data on the display screen 2. A data structure of the map information DB 13 is shown in FIG. 12. That is, the map information DB 13 has a plurality of pieces of map data at different scales.

In operation S314, the in-vehicle navigation apparatus determines whether an end instruction has been given from the user. If an end instruction has been given, the process is ended. Otherwise, the foregoing process is repeated until the vehicle reaches the final destination. The vehicle speed, the remaining speed, or the road type is read at times, and the scale is changed on the basis of the parameter value at the corresponding times, whereby a map is displayed at the changed scale on the display screen 2. The present invention is not limited to reading the vehicle speed, the remaining speed, and/or the road type at any particular point in time, and may read or detect information relative to a vehicle speed, a remaining speed and a road type at predetermined intervals, at time(s) set based on a distance remaining between a point of origin of a vehicle and a destination, etc.

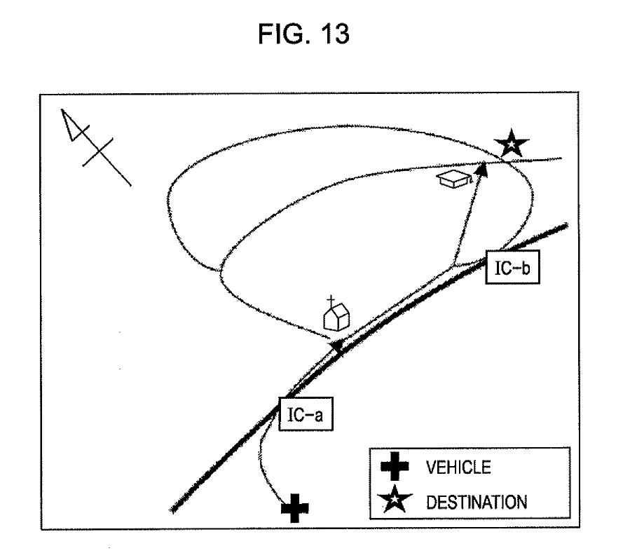

Next, FIGS. 13 to 15 show examples of screen(s) displayed in a case where an in-vehicle navigation apparatus operates in accordance with the above-described flowcharts. When the setting-entry accepting process (FIG. 3) and the moving-route determining process (FIG. 6) of the main flow shown in FIG. 2 end, a screen displaying the route from the current position to the final destination is displayed on the display screen 2, as shown in FIG. 13. A bald line in FIG. 13 indicates an expressway, IC indicates an interchange, and thin lines indicate other ordinary roads.

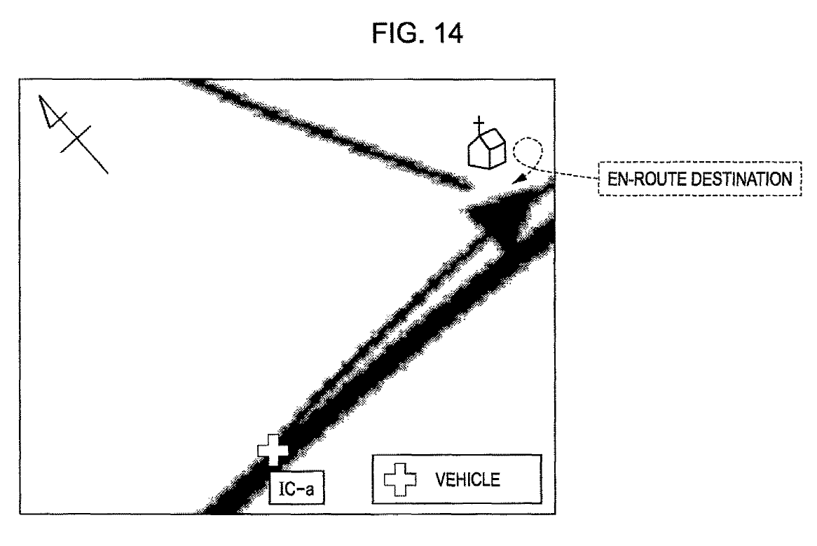

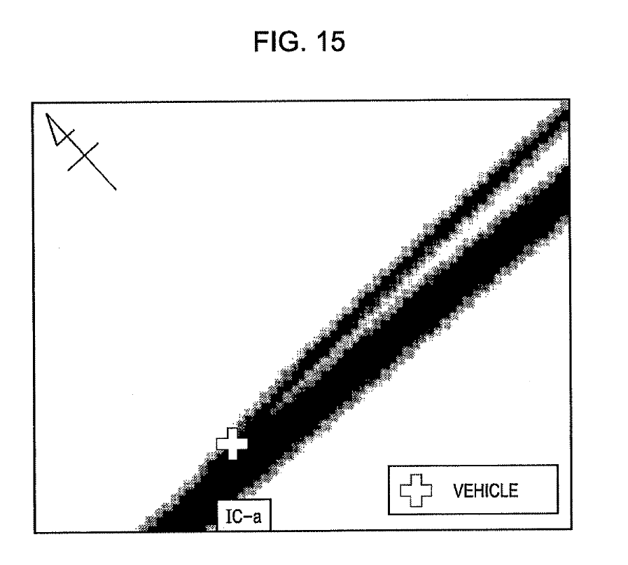

When the vehicle starts traveling and the display process (FIG. 8) starts, for example, the screens shown in FIGS. 14 and 15 are displayed. For example, in the case where the speed or the remaining distance is specified as the parameter for changing the scale, if the speed is fast or the remaining distance is long, a map is displayed at a relatively small scale, as shown in FIG. 14, so that the vehicle and the next en-route destination can be included in the screen. When the speed becomes slower or the remaining distance becomes shorter, a map is displayed at a relatively large scale, as shown in FIG. 15. FIGS. 14 and 15 illustrate the maps in which the current position of the vehicle is the same, and only the scale is different.

According to an embodiment, as has been described above, a scale of a displayed map is changed in accordance with one of parameter(s) for changing or adjusting a set scale. In circumstances where detailed information is expected to be necessary, a map at a large scale is displayed. If only rough information is sufficient, a map at a small scale is displayed. Accordingly, the scale can be automatically changed using the apparatus without requiring the user to change the scale. Necessary and sufficient information can be conveyed to the user according to circumstance(s).

According to an embodiment, only one parameter can be selected at a time to change a scale, a combination of a plurality of parameters can be selected according to another embodiment. A structure of an in-vehicle navigation apparatus enabling combination of a plurality of parameters is common to that shown in FIG. 1, and the main flow shown in FIG. 2 and the moving-route determining process shown in FIG. 6 are also common. Hereinafter, only portions that are different form the previously discussed embodiment will be described.

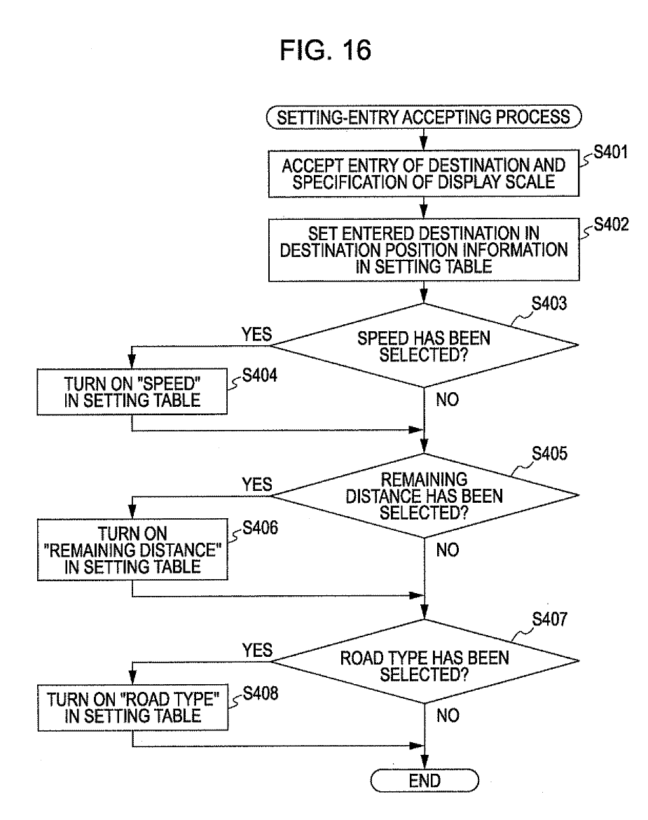

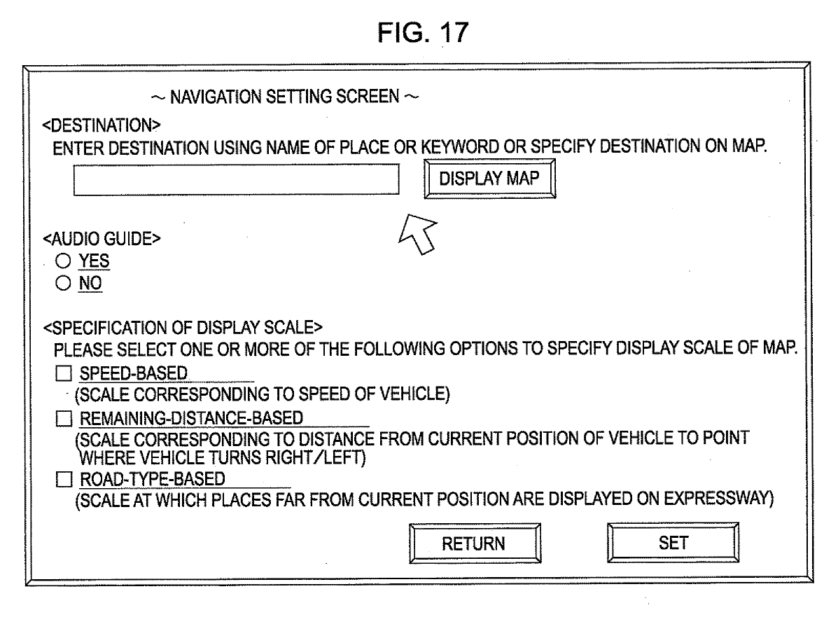

FIG. 16 is a flowchart showing a setting-entry accepting process according to an embodiment. In operation S401, an entry screen shown in FIG. 17 is displayed on the display screen 2, and an entry of a destination and specification of parameter(s) for changing a display scale are accepted. The entry screen includes a field for setting a destination, a field for setting an audio guide, and a field for setting a specification of a display scale. The field for setting the specification of the display scale includes, for example, three radio buttons for selecting corresponding item(s) including a speed, a remaining distance, and a road type. The user can select one, two, or three parameters from among these three items. As mentioned above, the present invention is not limited to any particular type of interface for selecting and indicating via the display screen 2.

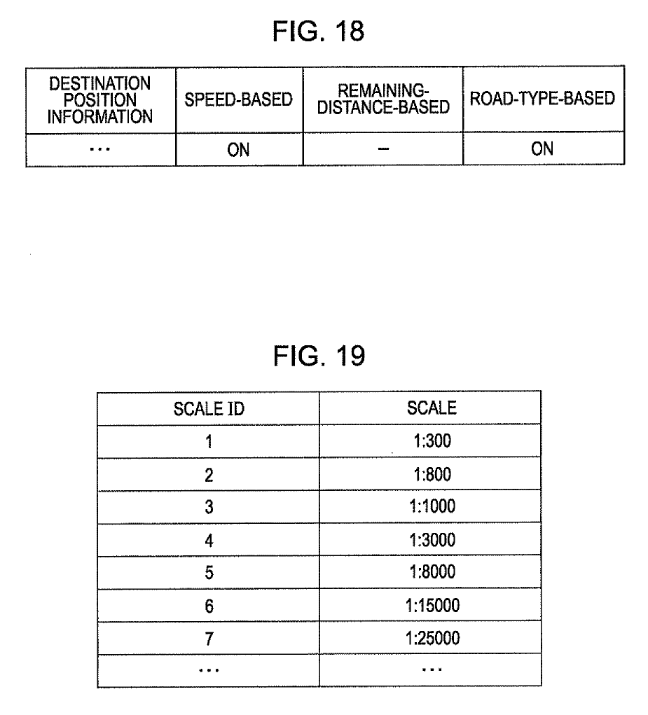

When the user enters necessary information on the entry screen, the input unit 12 registers in operation S402 the entered destination (final destination) in destination position information in a setting table. The setting table includes, as shown in FIG. 18, a field for storing destination position information and a field for storing specification of a parameter(s) for changing the display scale.

In operations S403 to S408, the input unit 12 determines which of the parameters has been set on the entry screen to change the scale and sets the determined parameter(s) in the setting table. In the example shown in FIG. 18, “speed” and “road type” are set as the parameters.

In particular, at operation S403, the process determines whether speed has been selected as a parameter. When determining that speed has been selected, the process proceeds to operation S404 of turning on (setting) speed in the setting table. When determining that speed has not been selected, the process proceeds to determining whether remaining distance has been selected as a parameter at operation S405.

When determining that the remaining distance has been selected, the process proceeds to operation S406 of turning on (setting) the remaining distance in the setting table. When the process determines that the remaining distance has not been selected, the process proceeds to operation S407 of determining whether a road type has been selected as a parameter.

When determining that the road type is selected as a parameter, the process proceeds to operation S408 of turning on (setting) the road type in the in setting table. When the process determines that a road type is not selected as a parameter at a determination of operation S407, the process ends.

Since the scale is determined based on a plurality of parameters according to an embodiment, a scale setting table shown in FIG. 19 is provided as a definition common to the parameter(s). This table stores the scale ID and the actual scale with a one-to-one correspondence.

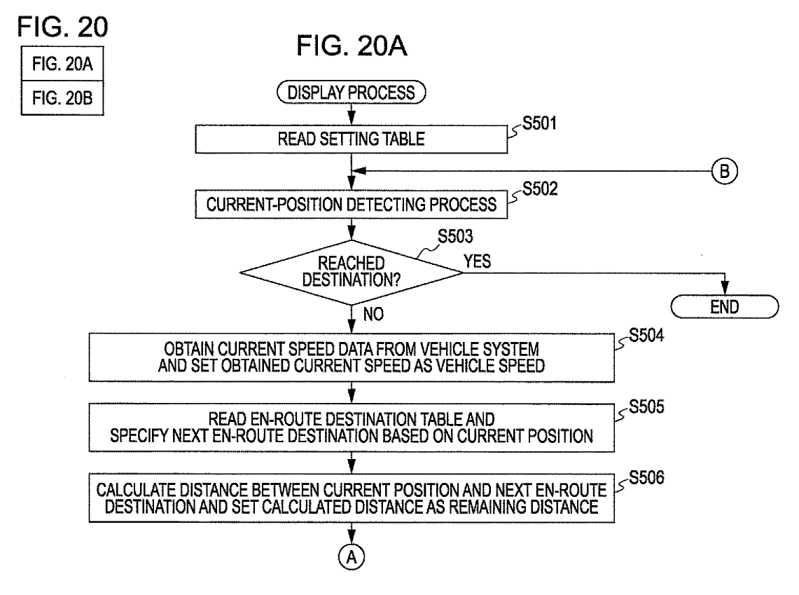

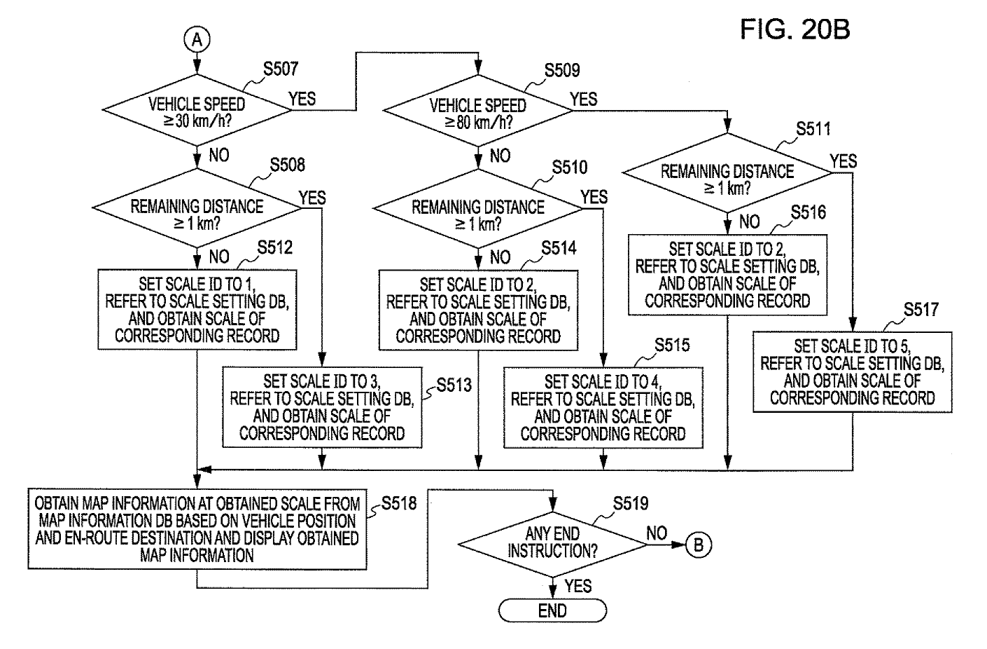

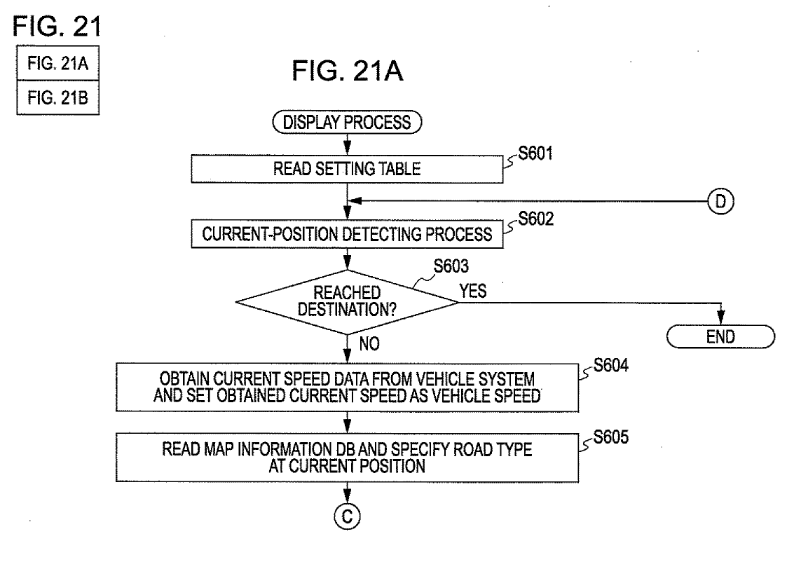

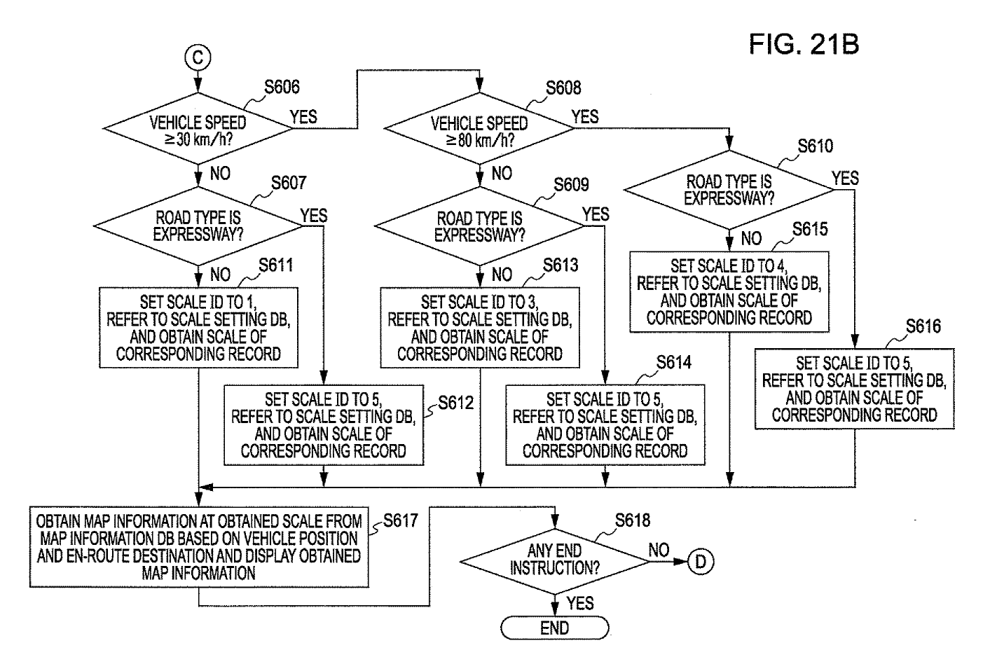

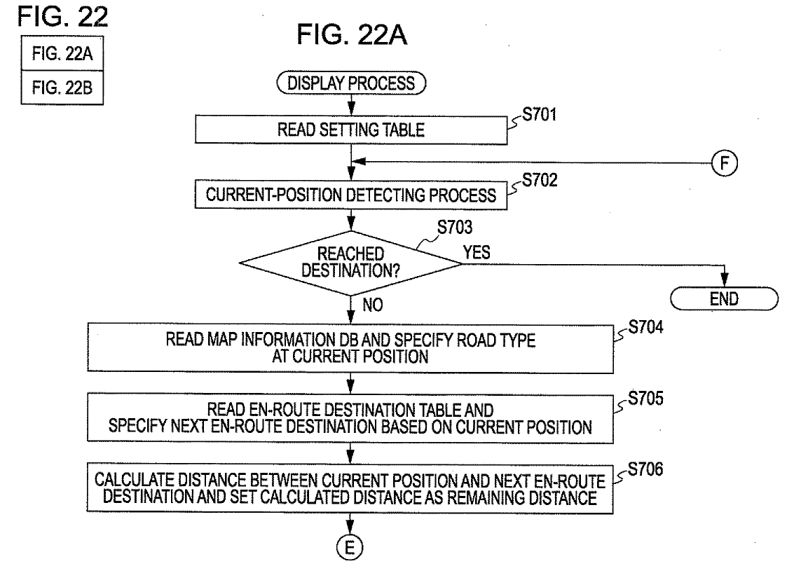

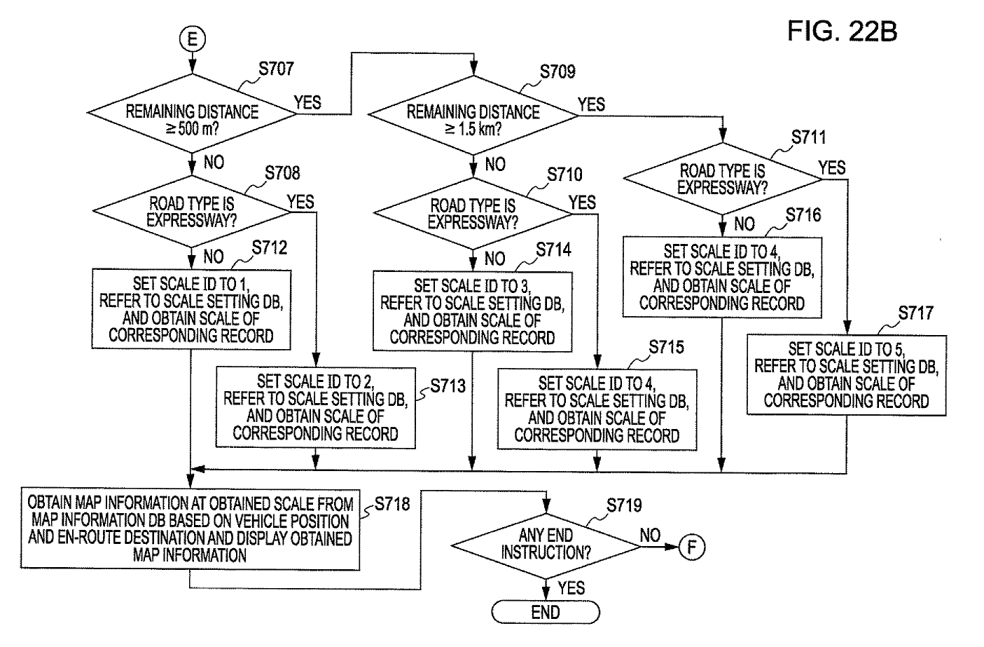

The basic flow of a display process of this embodiment is common to that of the previously described embodiment shown in FIG. 8. Note that, in this embodiment, since a plurality of combinations of parameters are conceivable and it may be complicated to show corresponding display processes using one flowchart, separate flowcharts are used to describe the corresponding combination(s) of parameter(s). That is, FIGS. 20A and 20B show a display process in a case where a speed and a remaining distance are selected as the parameters; FIGS. 21A and 21B show a display process in a case where a speed and a road type are selected as the parameters; and FIGS. 22A and 22B show a display process in a case where a remaining distance and a road type are selected as the parameters. These display processes will be described in their order.

First of all, in the case where a speed and a remaining distance are selected as the parameters, if the remaining distance is long while the speed is the same, the in-vehicle navigation apparatus displays a map at a small scale so that places far from a current position can be viewed at a glance. If the remaining distance is short while the speed is the same, the in-vehicle navigation apparatus displays a map at a large scale so that a neighborhood can be enlarged.

Operations S501 to S503 of FIG. 20A are the same as those of the display process of the previously described embodiment. The in-vehicle navigation apparatus reads the setting table to check the parameters, detects a current position, and determines whether a vehicle has reached a final destination. The process from operation S502 onward is repeated until it is determined in operation S503 that the vehicle has reached the final destination or an end instruction is given from the user in operation S519, which will be described below in detail.

In operation S5041 the vehicle speed detector 17 receives an output of the vehicle speed sensor 4 and sends a current speed data to the scale changing unit 20 in the screen display unit 15. In operation S505, the distance calculator 16 reads the en-route destination table and specifies a next en-route destination based on a current position. Thereafter, the distance calculator 16 calculates in operation S506 a distance between the current position and the next en-route destination and sends a calculated distance as the remaining distance to the scale changing unit 20 in the screen display unit 15.

The scale changing unit 20 determines a scale based on a combination of the vehicle speed and the remaining distance transmitted. That is, in the case where the determination obtained in operations S507 to S511 shows that the vehicle speed is less than 30 km/h and that the remaining distance is less than 1 km, the scale changing unit 20 sets the scale ID to “1”, and, if the remaining distance is 1 km or longer, the scale changing unit 20 sets the scale ID to “3”. In the case where the vehicle speed is 30 km/h or greater and less than 80 km/h, if the remaining distance is less than 1 km, the scale changing unit 20 sets the scale ID to “2”, and, if the remaining distance is 1 km or longer, the scale changing unit 20 sets the scale ID to “4”. In the case where the vehicle speed is 80 km/h or greater, if the remaining distance is less than 1 km, the scale changing unit 20 sets the scale ID to “2”, and, if the remaining distance is 1 km or longer, the scale changing unit 20 sets the scale ID to “5”. In any case, the scale changing unit 20 refers to the scale setting table shown in FIG. 19 to obtain a corresponding scale.

After the scale has been set, the screen display unit 15 reads in operation S518 map data at a selected scale from the map information DB 13 on the basis of the current position and the next en-route destination and displays the read map data on the display screen 2.

In operation S519, the in-vehicle navigation apparatus determines whether an end instruction has been given, for example, from a user. If an end instruction has been given, the process is ended. Otherwise, the foregoing process is repeated until the vehicle reaches the final destination. The vehicle speed and the remaining speed are read at times, and the scale is changed on the basis of parameter values at the corresponding times, whereby a map is displayed at the changed scale on the display screen 2.

Next, in the case where the speed and the road type are selected as parameters, if the road type is an expressway while the speed is the same, even when the speed is slow, it is highly likely that the speed will increase. Thus, the in-vehicle navigation apparatus displays a map at a small display so that places far from the current position can be viewed at a glance. If the road type is not an expressway, the in-vehicle navigation apparatus displays a map at a large scale so that the neighborhood can be enlarged.

Operations S601 to S603 of FIG. 21A are the same as those of the display process of the previously described embodiment. The in-vehicle navigation apparatus reads the setting table to check the parameters, detects the current position, and determines whether the vehicle has reached the final destination. The process from operation S602 onward is repeated until it is determined in operation S603 that the vehicle has reached the final destination or an end instruction is given from the user in operation S618, which will be described below in detail.

In operation S604, the vehicle speed detector 17 receives an output of the vehicle speed sensor 4 and sends a current speed data to the scale changing unit 20 in the screen display unit 15. In operation S605, the road-type determining unit 18 reads the map information DB 13, specifies a road type at the current position, and sends the specified road type to the scale changing unit 20 in the screen display unit 15.

The scale changing unit 20 determines a scale based on a combination of the vehicle speed and the road type transmitted. That is, in the case where the determination obtained in operations S606 to S610 shows that the vehicle speed is less than 30 km/h and that the road type is not an expressway, the scale changing unit 20 sets the scale ID to “1”, and, if the road type is an expressway, the scale changing unit 20 sets the scale ID to “5”. In the case where the vehicle speed is 30 km/h or greater and less than 80 km/h, if the road type is not an expressway, the scale changing unit 20 sets the scale ID to “3”, and, if the road type is an expressway, the scale changing unit 20 sets the scale ID to “5”. In the case where the vehicle speed is 80 km/h or greater, if the road type is not an expressway, the scale changing unit 20 sets the scale ID to “4”, and, if the road type is an expressway, the scale changing unit 20 sets the scale ID to “5”. In any case, the scale changing unit 20 refers to the scale setting table shown in FIG. 19 to obtain a corresponding scale.

After the scale has been set, the screen display unit 15 reads in operation S617 map data at the selected scale from the map information DB 13 on the basis of the current position and the next en-route destination and displays the read map data on the display screen 2.

In operation S618, the in-vehicle navigation apparatus determines whether an end instruction has been given from the user. If an end instruction has been given, the process is ended. Otherwise, the foregoing process is repeated until the vehicle reaches the final destination. The vehicle speed and the road type are read at times, and the scale is changed on the basis of the parameter values at the corresponding times, whereby a map is displayed at the changed scale on the display screen 2.

Finally, in the case where the remaining distance and the road type are selected as the parameters, if the road type is an expressway while the remaining distance is the same, there are generally only a few en-route destinations. Thus, the in-vehicle navigation apparatus displays a map at a small display so that places far from the current position can be viewed at a glance. If the road type is not an expressway, the in-vehicle navigation apparatus displays a map at a large scale so that the neighborhood can be enlarged.

Operations S701 to S703 of FIG. 22A are the same as those of the display process of the previously described embodiment. The in-vehicle navigation apparatus reads the setting table to check the parameters, detects the current position, and determines whether the vehicle has reached the final destination. The process from operation S702 onward is repeated until it is determined in operation S703 that the vehicle has reached the final destination or an end instruction is given from the user in operation S719, which will be described below in detail.

In operation S704, the road-type determining unit 18 reads the map information DB 13, specifies a road type at the current position, and sends the specified road type to the scale changing unit 20 in the screen display unit 15. In operation S705, the distance calculator 16 reads the en-route destination tale and specifies the next en-route destination based on the current position. Thereafter, the distance calculator 16 calculates in operation S706 a distance between the current position and the next en-route destination and sends the calculated distance as the remaining distance to the scale changing unit 20 in the screen display unit 15.

The scale changing unit 20 determines the scale based on a combination of the remaining distance and the road type transmitted. That is, in the case where the determination obtained in operations S707 to S711 shows that the remaining distance is less than 500 m and that the road type is not an expressway, the scale changing unit 20 sets the scale ID to “1”, and, if the road type is an expressway, the scale changing unit 20 sets the scale ID to “2”. In the case where the remaining distance is 500 m or greater and less than 1.5 km, if the road type is not an expressway, the scale changing unit 20 sets the scale ID to “3”, and, if the road type is an expressway, the scale changing unit 20 sets the scale ID to “4”. In the case where the remaining distance is 1.5 km or greater, if the road type is not an expressway, the scale changing unit 20 sets the scale ID to “4”, and, if the road type is an expressway, the scale changing unit 20 sets the scale ID to “5”. In any case, the scale changing unit 20 refers to the scale setting table shown in FIG. 19 to obtain a corresponding scale.

After the scale has been set, the screen display unit 15 reads in operation S718 map data at the selected scale from the map information DB 13 on the basis of the current position and the next en-route destination and displays the read map data on the display screen 2.

In operation S719, the in-vehicle navigation apparatus determines whether an end instruction has been given from the user. If an end instruction has been given, the process is ended. Otherwise, the foregoing process is repeated until the vehicle reaches the final destination. The remaining distance and the road type are read at times, and the scale is changed on the basis of the parameter values at the corresponding times, whereby a map is displayed at the changed scale on the display screen 2.

According to an embodiment, as has been described above, since a scale is set based on a combination of a plurality of parameters, a map can be displayed at an appropriate scale that can better meet the user's demand, compared with the case in which the scale is set based on a single parameter.

Although a few embodiments have been shown and described, it would be appreciated by those skilled in the art that changes may be made in these embodiments without departing from the principles and spirit of the invention, the scope of which is defined in the claims and their equivalents.

What is claimed is:

1. An in-vehicle navigation apparatus for displaying a route from a current position of a vehicle to a destination on a map on a display screen, comprising:
an input unit accepting an entry of a destination;
a position detector for detecting a current position;
a map-information storage unit storing a plurality of pieces of map information at different scales;
a route setting unit specifying a route from said current position detected by said position detector to said destination accepted by said input unit;
a distance calculator calculating a remaining distance from said current position to said destination or from said current position to a next en-route destination on said route set by said route setting unit;
a scale setting unit storing correspondence relationships between remaining distances and scales of said map to be displayed on said display screen; and
a screen display unit extracting a scale corresponding to said remaining distance calculated by said distance calculator from said scale setting unit, extracting map information having said scale corresponding to said remaining distance from said map-information storage unit, and displaying said map information on said display screen.

2. The in-vehicle navigation apparatus according to claim 1, comprising:
a road-type determining unit referring to said map-information storage unit based on said current position and determining a road type at said current position, and
wherein said scale setting unit stores a correspondence relationship of remaining distances and road types to scales of said map to be displayed on said display screen, and
said screen display unit extracts a scale corresponding to said remaining distance calculated by said distance calculator and said road type specified by said road-type determining unit from said scale setting unit, extracts map information having said scale corresponding to said remaining distance and said road type from said map-information storage unit, and displays said map information on said display screen.

3. An in-vehicle navigation apparatus for displaying a route from a current position of a vehicle to a destination on a map on a display screen, comprising:
an input unit accepting an entry of a destination;
a position detector for detecting a current position;
a map-information storage unit storing a plurality of pieces of map information at different scales;
a route setting unit specifying a route from said current position detected by said position detector to said destination accepted by said input unit;
a vehicle speed detector detecting a traveling speed of said vehicle;
a scale setting unit storing correspondence relationships between vehicle speeds and scales of said map to be displayed on said display screen; and
a screen display unit extracting a scale corresponding to said vehicle speed detected by said vehicle speed detector from said scale setting unit, extracting map information having said scale corresponding to said vehicle speed from said map-information storage unit, and displaying said map information on said display screen.

4. The in-vehicle navigation apparatus according to claim 3, comprising:
a distance calculator calculating a remaining distance from said current position to said destination or from said current position to a next en-route destination on said route set by said route setting unit, and
wherein said scale setting unit stores correspondence relationships of vehicle speeds and remaining distances to scales of said map to be displayed on said display screen, and said screen display unit extracts a scale corresponding to said vehicle speed detected by said vehicle speed detector and said remaining distance calculated by said distance calculator from said scale setting unit, extracts map information having said scale corresponding to said vehicle speed and said remaining distance from said map-information storage unit, and displays said map information on said display screen.

5. The in-vehicle navigation apparatus according to claim 3, comprising:
a road-type determining unit referring to said map-information storage unit based on said current position of said vehicle and determining a road type at said current position, and
wherein said scale setting unit stores correspondence relationships of vehicle speeds and road types to scales of said map to be displayed on said display screen, and
said screen display unit extracts a scale corresponding to said vehicle speed detected by said vehicle speed detector and said road type detected by said road-type determining unit from said scale setting unit, extracts map information having said scale corresponding to said vehicle speed and said road type from said map-information storage unit, and displays said map information on the display screen.

6. An in-vehicle navigation apparatus for displaying a route from a current position of a vehicle to a destination on a map on a display screen, comprising:
an input unit accepting an entry of a destination;
a position detector for detecting a current position;
a map-information storage unit storing a plurality of pieces of map information at different scales;
a route setting unit specifying a route from said current position detected by said position detector to said destination accepted by said input unit;
a road-type determining referring to said map-information storage unit based on said current position and determining a road type at said current position;
a scale setting unit storing correspondence relationships between road types and scales of said map to be displayed on said display screen; and
a screen display unit extracting a scale corresponding to said road type determined by said road-type determining unit from said scale setting unit, extracting map information having said scale corresponding to said road type from said map-information storage unit, and displaying said map information on said display screen.

7. An in-vehicle navigation method, comprising:
extracting a display scale corresponding to a current detected parameter of a vehicle moving relative to a destination; and
changing a display of a map in accordance with said display scale extracted and displaying the map at the display scale.
